(19) United States
(12) Patent Application Publication
(10) Pub. No.: US 2025/0298049 A1
(43) Pub. Date: Sep. 25, 2025

(54) TACHOMETER FOR AN AIRCRAFT WHEEL

(71) Applicant: SAFRAN LANDING SYSTEMS, VELIZY-VILLACOUBLAY (FR)

(72) Inventors: Eric EVENOR, MOISSY-CRAMAYEL (FR); Steve COUSTENOBLE, MOISSY-CRAMAYEL (FR); Paul WICKER, MOISSY-CRAMAYEL (FR); Joël ZABULON, MOISSY-CRAMAYEL (FR)

(73) Assignee: SAFRAN LANDING SYSTEMS, VELIZY-VILLACOUBLAY (FR)

(21) Appl. No.: 18/863,739

(22) PCT Filed: May 10, 2023
(86) PCT No.: PCT/EP2023/062518

§ 371 Date: Nov. 7, 2024

(30) Foreign Application Priority Data
May 13, 2022 (FR) 2204578

(51) Int. Cl. B64C 25/36; G01P 3/487

(52) U.S. Cl. CPC G01P 3/487

(57) ABSTRACT

A tachometer for an aircraft wheel is mounted on an axle so as to rotate about an axis of rotation. The tachometer includes a stator intended configured to be secured to the axle and a rotor configured to be rotatably connected to the wheel. Either the stator or the rotor has at least one contactless sensor with at least two measurement cells adapted to interact with a plurality of targets borne by the other of the stator or the rotor in order to generate two signals representative of a rotational speed of the wheel. The measurement cells are angularly offset from one another about the axis so as to detect a direction of rotation of the wheel by combining the two signals.

The present invention relates to a tachometer for an aircraft wheel.

### BACKGROUND OF THE INVENTION

Aircraft landing gears are conventionally provided with tachometers for continuously measuring the rotational speed of the wheels of the landing gears. The measured speeds constitute basic data for the anti-skid and anti-lock braking systems of the wheels. Tachometers are therefore measurement means whose accuracy and reliability are essential.

Aircraft wheels are conventionally mounted on an axle so as to rotate about an axis of rotation. The tachometers comprise a fixed part intended to be rigidly connected to the axle, and a movable part intended to be rotated by the wheel. The fixed part comprises a sensor having a single Hall effect measurement cell arranged to be positioned radially opposite magnetic targets borne by the rotating part in order to generate information on the rotational speed of the wheel.

In general, the rotating part is rotationally guided with respect to the fixed part by means of bearings and comprises a catch which interacts with a protective cover rigidly connected to the wheel in order for the rotating part to rotate.

To overcome the problem of wear on the bearings, document FR-A-2888329 envisages rigidly connecting the rotating part to the protective cover of the wheel. The rotating part is then centred with respect to the fixed part without any guide device extending between said fixed part and said rotating part.

Nevertheless, the lack of a bearing means there has to be a relatively large air gap between the fixed part 1 Translation of the title as established ex officio. and the rotating part to avoid any mechanical interference between said fixed part and said rotating part. However, Hall effect measurement cells that allow the rotational speed of a wheel to be measured as effectively as with measurement cells of a prior-art tachometer are not compatible with the air gap size required to avoid any risk of mechanical interference.

Moreover, such tachometers do not allow the direction of rotation of the wheels to be determined, which can be very useful during electric taxiing phases.

### OBJECT OF THE INVENTION

The object of the invention is therefore to propose a use of a contactless sensor for avoiding at least some of the above-mentioned drawbacks.

### SUMMARY OF THE INVENTION

For this purpose, the invention proposes a use of a contactless sensor comprising at least two measurement cells for increasing an acceptable air gap between a stator and a rotor of a tachometer for an aircraft wheel. The stator is intended to be secured to an axle, and the rotor is intended to be rotatably connected to the wheel mounted on the axle so as to rotate about an axis of rotation, either the stator or the rotor bearing the sensor, the measurement cells of which are adapted to interact with a plurality of targets borne by the other of the stator or the rotor in order to generate two signals representative of a rotational speed of the wheel, and the measurement cells being offset angularly from one another about the axis so as to detect a direction of rotation of the wheel by combining the two signals.

By using two measurement cells, the rotational speed of the wheel can be measured at a higher frequency than when a single measurement cell is used, and so the number of targets can be reduced while the size thereof is increased. The acceptable air gap for the measurement cells is generally directly related to the size of the targets. Increasing the size of the targets therefore makes it possible to increase the air gap between the stator and the rotor, and thus to limit the mechanical interference between said stator and said rotor.

According to a particular embodiment, the contactless sensor is borne by the stator and the targets are borne by the rotor.

According to a particular feature, the contactless sensor is a Hall effect sensor.

According to another particular feature, the rotor comprises a toothed ring having a plurality of teeth regularly angularly distributed about the axis to form the targets.

In particular, the toothed ring is made of paramagnetic material so that the teeth form magnetic targets.

According to another particular feature, the measurement cells extend opposite the targets in a radial direction during operation.

According to another particular feature, the rotor comprises a wheel cover intended to be secured to the wheel.

### BRIEF DESCRIPTION OF THE DRAWINGS

The invention will be better understood in the light of the following description, which is purely illustrative and non-limiting and should be read with reference to the accompanying drawings, in which:

FIG. 1 is a simplified view of an aircraft comprising main landing gears having wheels provided with a tachometer according to the invention;

FIG. 2 is an axial cross-sectional view of one of the wheels of the aircraft shown in FIG. 1;

FIG. 3 is a perspective view of the tachometer of the invention shown in FIG. 2;

FIG. 4 is an exploded view of the stator of the tachometer shown in FIG. 3;

FIG. 5 is an exploded view of the rotor of the tachometer shown in FIG. 3;

FIG. 6 is a view showing the signals delivered by the measurement cells of one of the contactless sensors fitted to the stator shown in FIG. 5.

### DETAILED DESCRIPTION OF THE INVENTION

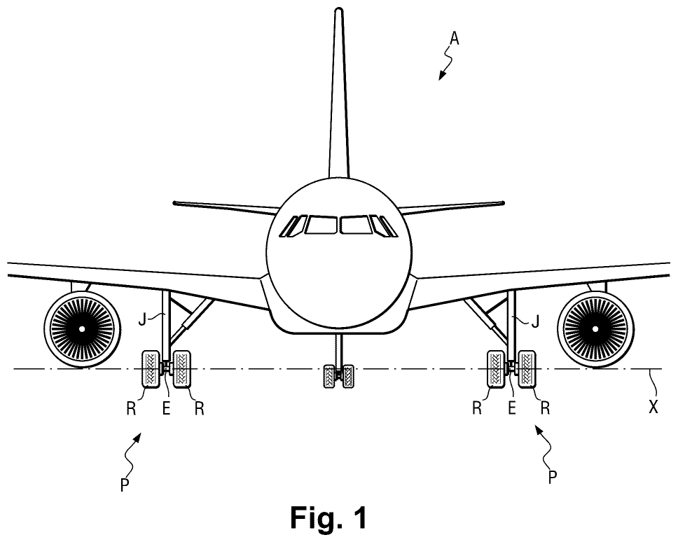

With reference to FIG. 1, the invention applies to an aircraft A comprising main landing gears P, each comprising a strut J having a first end hinged to a structure of the aircraft A and a second end bearing two wheels R received on an axle E so as to be pivotable about an axis X.

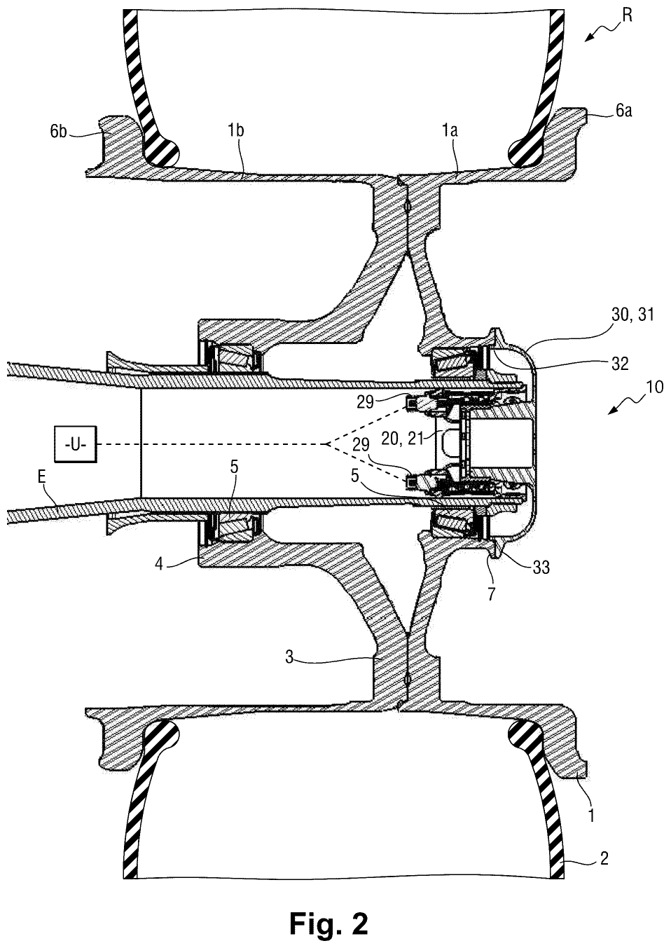

In accordance with FIG. 2, each wheel R comprises an annular rim 1 on which a tyre 2 is mounted. The rim 1 is connected by a disc 3 to a hub 4 mounted on the axle E so as to rotate about the axis X by means of tapered roller bearings 5. In a manner known per se, the rim 1 in this case comprises two half rims 1a, 1b which are assembled together by bolts and which each comprise a bead 6a, 6b detaining the tyre 2 on the rim 1.

According to the invention, the wheel R comprises a tachometer 10 mounted at the end of the axle E for measuring the angular rotational speed of the wheel R about the axis X. The following description relates to a single wheel R, but the invention of course applies equally to all or some of the wheels R of the landing gears P.

The tachometer 10 comprises a stator 20 which is inserted into a free end of the axle E and secured to this free end by means of two bolts (not shown) such that the stator 20 cannot move relative to said axle E.

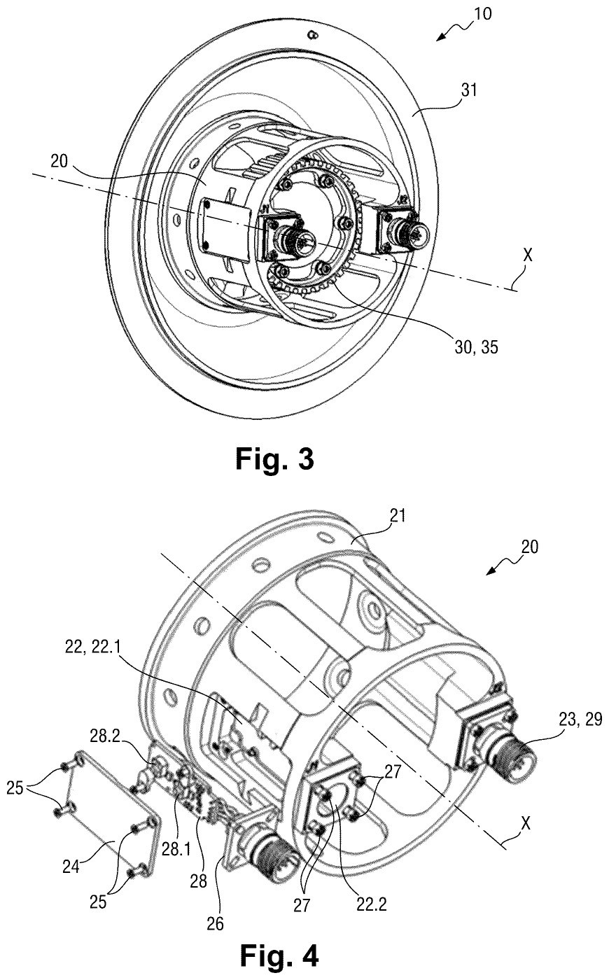

With reference to FIGS. 3 and 4, the stator 20 comprises a body 21 that has a generally tubular shape and extends along an axis that substantially coincides with the axis of rotation X of the wheel R. The body 21 internally comprises two cavities 22 that are diametrically opposite one another with respect to the axis X. A Hall effect sensor 23 is housed inside each of the cavities. Two Hall effect sensors 23 are used to ensure the redundancy necessary for the reliability of the tachometer 10.

The cavities 22 are identical and each comprise a side opening 22.1 facing in a radial direction towards the outside of the body 21, and a front opening 22.2 facing in an axial direction towards one end of the body 21 and through which the Hall effect sensor 23 is inserted. The side opening 22.1 is generally rectangular in shape and is closed by a sealed cover 24 secured to the body 21 by means of four screws 25. The front opening 22.2 is generally square in shape and is closed by a plate 26 of the Hall effect sensor 23, said Hall effect sensor 23 being secured to the body 21 using said plate by means of four screws 27.

The Hall effect sensors 23 are identical and each comprise an electronic board 28 having two Hall effect measurement cells 28.1, 28.2 that are turned towards the X axis in a radial direction. In this case, the measurement cells 28.1, 28.2 are identical and substantially equidistant from the axis X. The electronic board 28 is connected to a connector 29 suitable for supplying electric power to the electronic board 28 and for transmitting signals delivered by the measurement cells 28.1, 28.2 to an electronic processing unit U. The electronic board 28 and the connector 29 each extend on one side of the plate 26, the electronic board 28 extending inside the cavity 22 and the connector 29 extending outside the cavity 22. The Hall effect sensor 23 is connected, via a cable coupled to the connector 29, to the electronic processing unit U, which is integrated in a remote computer located in a compartment of the landing gear P. In this case, the electronic processing unit 31 comprises, in a manner known per se, a processor and a memory containing a program executed by the processor.

As can be seen in FIG. 4, the measurement cells 28.1, 28.2 are offset axially from each other in a direction parallel to the axis X. The measurement cells 28.1, 28.2 are also offset angularly from each other about the axis X so that the direction of rotation of the wheel R about said axis X can be detected, as will be explained later.

It is noted that enclosing the electronic boards 28 and the measurement cells 28.1, 28.2 of the Hall effect sensors 23 in the cavities 22 of the body 11 protects them from external damage.

The tachometer 10 also comprises a rotor 30 which, according to the invention, is secured to the rim 1 of the wheel R such that the rotor 30 cannot move relative to said wheel R.

With reference to FIGS. 3 and 5, the rotor 30 comprises a wheel cover 31 that is arranged to protect the inside of the free end of the axle E and forms a portion visible from the outside of the tachometer 10. The wheel cover 31 is coupled to the rim 1 and, for this purpose, comprises a first cylindrical bearing surface 32 which interacts with a corresponding bearing surface of the rim 1 to centre the wheel cover 31 with respect to the rim 1 and the axis of rotation X of the wheel R. The wheel cover 31 is secured and prevented from rotating on the rim 1 by means of a peripheral clamping collar (not shown) that clamps together a tapered bearing surface 33 of the wheel cover 31 and a symmetrical tapered bearing surface 7 of the rim 1.

The wheel cover 31 also comprises a second cylindrical bearing surface 34 which is coaxial with the first cylindrical bearing surface 32 and to which a toothed ring 35 made of paramagnetic steel is secured by means of six screws 36. The toothed ring 35 is thus centred on the axis X and cannot move relative to the wheel cover 31 and thus relative to the rim 1. As can be seen in FIG. 3, the toothed ring 35 extends inside the stator 20 and comprises straight toothing having a plurality of teeth 37 regularly angularly distributed about the axis X. Two adjacent teeth 37 are separated by a space of a width that is substantially the same as that of said teeth 37. Each of the teeth 37 forms a magnetic target which, during operation, passes opposite each of the measurement cells 28.1, 28.2 of the Hall effect sensors 23 in a radial direction. In this case, the angular offset of the measurement cells 28.1, 28.2 about the axis X corresponds substantially to that of a half-tooth 37. It is noted that centring the wheel cover 31 on the rim 1 allows the stator 20 and the rotor 30 to be centred on the axis of rotation X of the wheel R without any rotation guide device extending between said stator 20 and said rotor 30. The stator 20 and the rotor 30 thus constitute two autonomous elements that can be mounted independently of each other on the associated member (axle E or wheel R).

During operation, the wheel R rotating about the axis X causes the wheel cover 31, and therefore the toothed ring 35, to also rotate about said axis X. The teeth 37 of the toothed ring 35 thus successively pass in front of the measurement cells 28.1, 28.2 and then each generate a signal S₁, S₂, the frequency of which is representative of a rotational speed of the toothed ring 35, and therefore of the wheel R, according to a method known per se.

The electronic processing unit U is programmed to use the signals in the manner explained below.

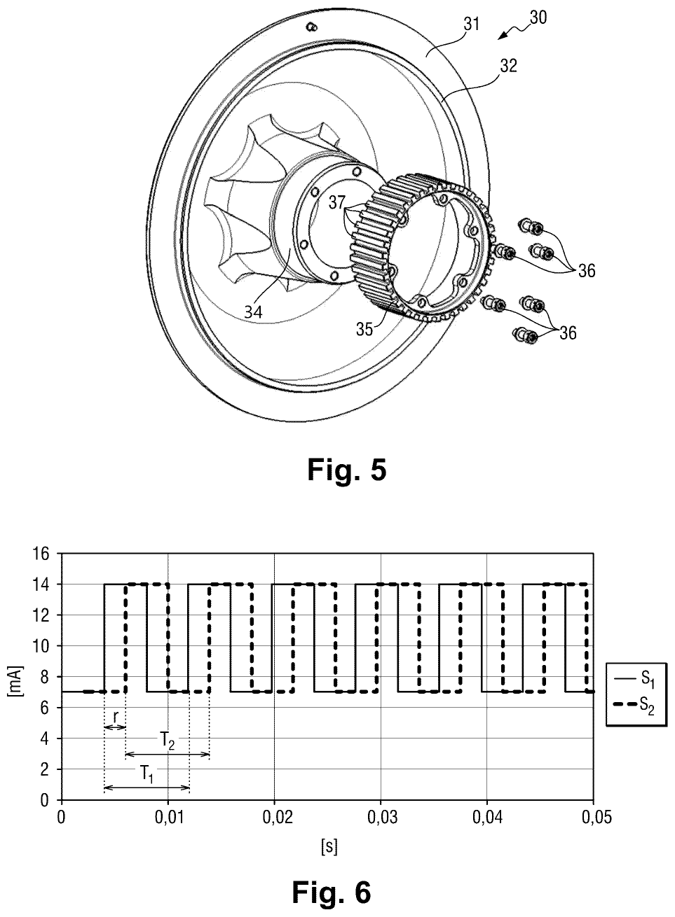

The graph in FIG. 6 shows the signals S₂ generated by the two measurement cells 28.1, 28.2 of one of the Hall effect sensors 23, the wheel R rotating about the axis X at a substantially constant speed V. The signal S₁ generated by the measurement cell 28.1 is substantially in the form of a periodic square-wave signal whose period T₁ is substantially equal to 8 milliseconds and whose low and high values are substantially equal to 7 milliamperes and 14 milliamperes, respectively. The signal S₂ generated by the measurement cell 28.2 is identical to the signal S₁ but is temporally shifted by a time lag r, which in this case is substantially equal to 2 milliseconds taking account of the speed V. Thus, the signal S₂ is in the form of a periodic square-wave signal whose period T₂ is the same as the period T₁ of the signal S₁ and whose low and high values are the same as those of the signal S₁.

As is known per se, knowing the number of teeth 37 comprised by the toothing of the toothed ring 35 makes it possible to deduce the rotational speed of said toothed ring 35, and therefore of the wheel R, from the signal S₁ (or the signal S₂). Moreover, knowing the spacing between the teeth makes it possible to determine the rotational speed from the time between two slots; the more slots used, the greater the accuracy.

Furthermore, analysing the time lag r between the signal S₁ and the signal S₂ makes it possible to determine the direction of rotation of the toothed ring 35 and therefore of the wheel R. It can be seen, for example, in FIG. 6 that the signal S₂ lags behind the signal S₁, which means that the toothed ring 35 is rotating from the measurement cell 28.1 towards the measurement cell 28.2. Conversely, if the signal S₁ lags behind the signal S₂, this means that the toothed ring 35 is rotating from the measurement cell 28.2 towards the measurement cell 28.1. It is thus possible for the computer receiving the signals S₁, S₂ to define the direction of rotation of the wheel R.

Furthermore, using the rising and falling edges of the signals S₁, S₂ makes it possible to obtain a measurement of the rotational speed V of the wheel R at a higher frequency than that obtained by using the rising and falling edges of the sole signal S₁ (or of the sole signal S₂). It can be seen, for example, in FIG. 6 that during a period of time equal to the period T₁ (or to the period T₂), two rising edges and two falling edges can be observed when both signals S₁, S₂ are used whereas only a single rising edge and a single falling edge can be observed when just one of the two signals S₁, S₂ is used. It is therefore possible for the computer receiving the two signals S₁, S₂ to determine the rotational speed V of the wheel R at twice the frequency by combining the use of the signal S with the use of the signal S₂.

While using two measurement cells 28.1, 28.2 makes it possible to increase the frequency with which the rotational speed V of the wheel R is determined, it can also allow the number of teeth 37 of the toothed ring 35 to be reduced without impairing the performance of the tachometer 10 for a given resolution frequency.

For example, using the rising and falling edges of both the signal S₁ and the signal S₂ makes it possible to obtain, for a toothed ring 35 having fifty teeth, the same resolution frequency as a tachometer which comprises a toothed ring having two hundred teeth and a Hall effect sensor having a single measurement cell for which only the rising edges of the delivered signal are used.

For example, using the rising and falling edges of the signals delivered by a Hall effect sensor having four measurement cells makes it possible to obtain, for a toothed ring 35 comprising twenty-five teeth, the same resolution frequency as a tachometer which comprises a toothed ring having two hundred teeth and a Hall effect sensor having a single measurement cell for which only the rising edges of the delivered signal are used.

The advantage of reducing the number of teeth 37 of the toothed ring 35 is that the size of the teeth 37 can be increased, and so the mechanical manufacturing constraints on said toothed ring 35 can be lessened, but also a larger air gap can be allowed between the teeth 37 and the measurement cells 28.1, 28.2 for a given resolution frequency.

It goes without saying that the invention is not limited to the described embodiment but covers any variant falling under the scope of the invention as defined by the claims.

Although the stator 20 comprises two Hall effect sensors in this case, it may also comprise just one, the second simply providing redundancy in the event that the first fails. The number of sensors may also be more than two.

Although the Hall effect sensor 23 comprises two measurement cells 28.1, 28.2 in this case, it may also comprise more than two.

The Hall effect sensors 23 need not necessarily be diametrically opposite one another and may be angularly offset by an angle other than 180° about the X axis.

Although the sensors 23 are Hall effect sensors in this case, other contactless sensors may be used, for example eddy current sensors, magnetoresistive sensors (e.g. anisotropic magnetoresistance (AMR), giant magnetoresistance (GMR), tunnel magnetoresistance (TMR) sensors, etc.), optical sensors, etc.

The Hall effect sensors may be borne by the rotor 30 and the magnetic targets 37 by the stator 20.

1. A contactless sensor comprising at least two measurement cells configured to increase an acceptable air gap between a stator and a rotor of a tachometer for an aircraft wheel, the stator being configured to be secured to an axle, and the rotor being configured to be rotatably connected to the wheel mounted on the axle so as to rotate about an axis of rotation, one of the stator or the rotor bearing the contactless sensor, the measurement cells of which are adapted to interact with a plurality of targets borne by the other of the stator or the rotor in order to generate two signals representative of a rotational speed of the wheel, the measurement cells being offset angularly from one another about the axis so as to detect a direction of rotation of the wheel by combining the two signals.

2. The contactless sensor according to claim 1, wherein the contactless sensor is borne by the stator and the targets are borne by the rotor.

3. The contactless sensor according to claim 1, wherein the contactless sensor is a Hall effect sensor.

4. The contactless sensor according to claim 1, wherein the rotor comprises a toothed ring having a plurality of teeth regularly angularly distributed about the axis to form the targets.

5. The contactless sensor according to claim 4, wherein the toothed ring comprises a paramagnetic material so that the teeth form magnetic targets.

6. The contactless sensor according to claim 1, wherein the measurement cells extend opposite the targets in a radial direction during operation.

7. The contactless sensor according to claim 1, wherein the rotor comprises a wheel cover configured to be secured to the wheel.
